(19) United States
(12) Patent Application Publication
(10) Pub. No.: US 2026/0163478 A1
(43) Pub. Date: Jun. 11, 2026

(54) BI-DIRECTIONAL POWER FACTOR CORRECTION CONTROL

(71) Applicant: Renesas Electronics Corporation, Tokyo (JP)

(72) Inventors: Ligang SONG, Beijing (CN); Hongyan ZOU, Beijing (CN)

(73) Assignee: Renesas Electronics Corporation, Tokyo (JP)

(21) Appl. No.: 19/178,249

(22) Filed: Apr. 14, 2025

(30) Foreign Application Priority Data
Apr. 16, 2024 (CN) 202410458042.3

(51) Int. Cl. H02M 1/42; H02M 1/00; H02M 1/08; H02M 7/219

(52) U.S. Cl. CPC H02M 1/4233; H02M 1/0009; H02M 1/08; H02M 7/219

(57) ABSTRACT

Apparatuses, devices, and systems for operating a voltage converter to reduce current spike are described. A controller can measure a feedback of a current of an alternating current (AC) voltage of a switching circuit. The controller can measure a direct current (DC) voltage of the switching circuit. The controller can operate a current control loop using the feedback of the current to determine a target voltage. The controller can determine a duty cycle of the switching circuit based on the target voltage and the DC voltage. The controller can operate the switching circuit under the determined duty cycle to control the current of the AC voltage.

### BACKGROUND

The present disclosure relates to systems, devices and methods for power factor correction in power applications.

High power factor and high efficiency are key requirements for AC/DC power converters used in servers, networking, 5G telecommunications, industrial systems, electric vehicles, and a wide range of other applications. AC and DC components in AC/DC power converters can impact the efficiency of the AC/DC power converter, which can be represented by the ratio of the input power to the output power. However, the input power to the AC/DC power converters may not be purely sinusoidal, resulting in mismatches between the input AC current and input AC voltage and these mismatches can impact the efficiency. Power factor correction (PFC) circuits can be used for forcing an input AC current to follow the input AC voltage such that the power factor is as close to one as possible.

### SUMMARY

In one embodiment, a method for operating a voltage converter to reduce current spikes is generally described. The method can include measuring an alternating current (AC) voltage of a switching circuit. The method can further include measuring a direct current (DC) voltage of the switching circuit. The method can further include operating a current control loop using the AC voltage and the DC voltage to determine a target voltage. The method can further include determining a duty cycle of the switching circuit based on the target voltage. The method can further include operating the switching circuit under the determined duty cycle to control an AC current of the AC voltage.

In one embodiment, a semiconductor device for operating a voltage converter to reduce current spikes is generally described. The semiconductor device can include a switching circuit, a gate driver configured to drive at least one switch in the switching circuit and a controller. The controller can be configured to measure a feedback of a current of an alternating current (AC) voltage of the switching circuit. The controller can be further configured to measure a direct current (DC) voltage of the switching circuit. The controller can be further configured to operate a current control loop using the feedback of the current and the DC voltage to determine a target voltage. The controller can be further configured to determine a duty cycle of the switching circuit based on the target voltage. The controller can be further configured to generate control signals for the gate driver to drive the switching circuit under the determined duty cycle to control the current of the AC voltage.

In one embodiment, a semiconductor device for operating a voltage converter to reduce current spikes is generally described. The semiconductor device can include a controller configured to measure a feedback of a current of an alternating current (AC) voltage of a switching circuit. The controller can be further configured to measure a direct current (DC) voltage of the switching circuit. The controller can be further configured to operate a current control loop using the feedback of the current and the DC voltage to determine a target voltage. The controller can be further configured to determine a duty cycle of the switching circuit based on the target voltage. The controller can be further configured to operate the switching circuit under the determined duty cycle to control the current of the AC voltage.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is diagram showing an example system the bi-directional digital power factor correction in one embodiment.

FIG. 2 is diagram showing different operation modes of an AC/DC converter in accordance with bi-directional digital power factor correction in one embodiment.

FIG. 3 is diagram showing an implementation of a grid-connected inverter or a power factor correction mode controller in bi-directional digital power factor correction in one embodiment.

FIG. 4 is diagram showing an implementation of an off-grid inverter mode controller in bi-directional digital power factor correction in one embodiment.

FIG. 5A is diagram showing a result of an implementation of bi-directional digital power factor correction in one embodiment.

FIG. 5B is diagram showing another result of an implementation of bi-directional digital power factor correction in one embodiment.

FIG. 6 is a flow diagram illustrating a process to implement bi-directional digital power factor correction in one embodiment.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

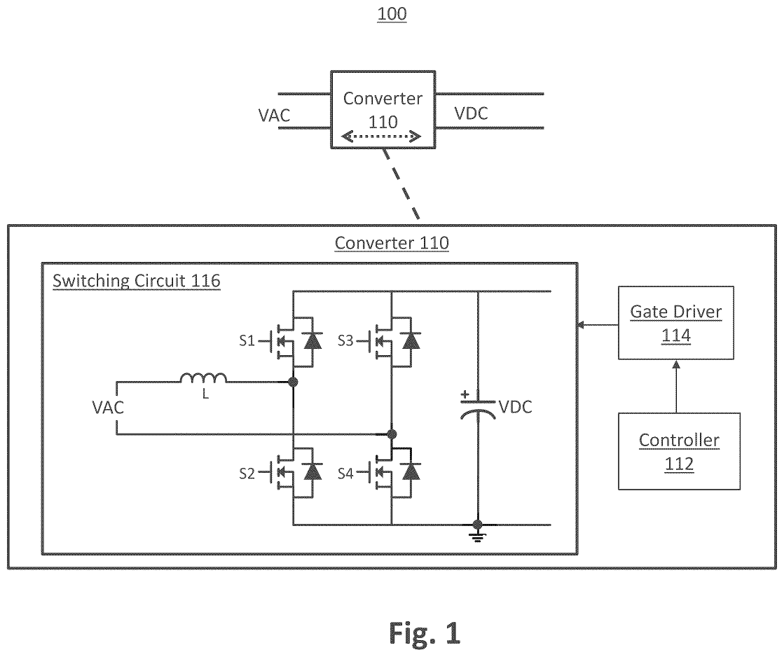

FIG. 1 is diagram showing an example system the bi-directional digital power factor correction in one embodiment. System 100 can implement a power receiver configured to receive an input voltage and convert the input voltage into an output voltage. System 100 can include a voltage converter 110 (herein “converter 110”). In one embodiment, converter 110 can be a bidirectional voltage converter that can convert alternating current (AC) voltage VAC into a direct current (DC) voltage VDC or convert VDC into VAC. Under a PFC mode, converter 110 can convert VAC into VDC and supply DC power demanded by a DC load in the form of DC voltage VDC. Under a grid-connected mode, converter 110 can directly convert VDC to an AC grid voltage (e.g., the grid connected to converter 110). Under a an off grid mode, converter 110 can convert VDC into VAC and provide VAC to an AC load that can be connected to the VAC side of converter 110. By way of example, if the DC load is a battery, converter 110 can convert VAC into VDC when charging the battery, and can convert VDC into VAC when discharging the battery.

Converter 110 can include at least a controller 112, a gate driver 114 and a switching circuit 116. Controller 112 can include one or more semiconductor devices implementing, for example, a microcontroller including hardware such as various analog and digital circuit components. Controller 112 can include, for example, a processor, central processing unit (CPU), field-programmable gate array (FPGA) or any other circuitry that is configured to control and operate various aspects of power stages 104. Controller 112 be configured to control various aspects of gate driver 114 and/or switching circuit 116. Controller 112 can include a pulse width modulation (PWM) generator configured to generate PWM control signals for turning on and turning off switches in switching circuit 116. Gate driver 114 can include a plurality of drivers (or driver circuits) that can receive the PWM control signals and convert the PWM control signals into drive signals that can be gate voltages for driving switches in switching converter 116. Converter 110 can be a bi-directional AC/DC converter that operates based on digital control. In one embodiment, AC/DC converter 110 can be a voltage source converter.

Switching circuit 116 can be a full-bridge (e.g., H-bridge) circuit implementing a totem pole full-bridgeless power factor correction (PFC) that integrates a rectifier circuit and a smoothing circuit. Switching circuit 116 can include two high-side switches S1, S3 and can include two low-side switches S2, S4. Switches S1, S2, S3, S4 can be metal-oxide-semiconductor field-effect transistors (MOSFETs), insulated gate bipolar transistors (IGBT), Silicon Carbide (SiC) MOSFETs, or other types of switching devices. Switching circuit 116 can further include boost inductor L. The boost inductor can be charged or discharged depending on which switches among switches S1, S2, S3, S4 are turned on (e.g., closed) and turned off (e.g., opened). The switching of switches S1, S2, S3, S4 can transform the AC voltage VAC into the DC voltage VDC, or transform the DC voltage VDC into the AC voltage VAC. In one embodiment, the switches S1, S2 can be a first bridge arm implementing high frequency switching and the switches S3, S4 can be a second bridge arm implementing low frequency switching. By way of example, the low frequency switches S3, S4 can switch at AC line frequency when VAC transitions between positive and negative cycles while the high frequency switches S1, S2 can switch at different switching frequencies.

In one embodiment, switches S1, S2, S3, S4 can be a hybrid Silicon Carbide-Silicon (SiC—Si) MOSFET that combines Silicon Carbide (SiC) and Silicon (Si) materials in a single MOSFET structure. The implementation of hybrid SiC—Si MOSFETs as witches S1, S2, S3, S4 can allow AC/DC converter 110 to operate in continuous conduction mode (CCM) at high switching frequencies with relatively high efficiency bidirectional energy conversion. Converter 110 can operate under three different operation modes, namely PFC, grid-connected inverter, and off-grid inverter. When converter 110 operates as PFC, converter 110 can convert AC voltage VAC into DC voltage VDC. When converter 110 operates as the grid-connected inverter or the off-grid inverter, converter 110 can convert DC voltage VDC into AC voltage VAC. Converter 110 can be used in various applications, such as energy storage, on-board charger (OBC), new energy grid-connected power generation, battery formation, or other applications that require single or bidirectional AC/DC power conversion.

In an aspect, the AC voltage VAC can include positive half cycle and negative half cycle. Positive half cycle is when the current IAC of VAC flows from VAC's positive terminal to the negative terminal. Negative half cycle is when the current IAC of VAC flows from VAC's negative terminal to the positive terminal. As VAC transitions between the positive half cycle and the negative half cycle, the current IAC can switch directions hence crossing a zero-current point. Current spikes, including positive and negative current spikes, can occur at this zero-current crossing point due to various factors. For example, the turn-on and turn-off sequence of the switches, slow reverse-recovery of the switches' body diode, large output capacitance of the switches, sudden turn on of the switches with almost 100% duty cycle, and other factors. These current spikes can lead to poor Total harmonic distortion (THD) and affect electromagnetic interference (EMI).

Some conventional systems can use a soft-start sequence to gradually increase the duty cycle to the target value, or turn off all switches near the zero crossing point to reduce the current spikes. However, soft-start on or turning off all switches increases software computational overhead and code complexity. Further, turning off the switches at the zero-crossing point can cause IAC to be in an uncontrollable state of freewheeling, and a current loop control being implemented by controller 112 will be forced to stop. This is not suitable for applications that require power factor correction where the current is non-zero at the zero-crossing point. Further, the state of the low-frequency switches S3, S4 remains unchanged within the half cycles (e.g., positive or negative cycles), thus allowing only unipolar modulation within the half cycles. Due to the limitation on performing only unipolar modulation within half cycles, there is an excessive reliance on high-precision phase-locked loops or other information to accurately determine VAC's polarity, which may be needed to identify the zero crossing point for timing the soft-start or shutting down all switches.

In an aspect, controller 112 can be configured to implement a DC voltage outer control loop to regulate the DC voltage (e.g., grid-connected or PFC modes), implement an AC voltage outer control loop to regulate the AC voltage (e.g., off-grid mode). Controller 112 can also implement a current inner control loop to regulate the current IAC regardless of whether converter 110 is operating as grid-connected, PFC, or off-grid mode. To be described in more detail below, controller 112 described herein can be configured to implement a current control loop that can regulate IAC under different operation modes, such as PFC, grid-connected and off-grid modes, during switching of S1, S2, S3, S4 to reduce or remove current spikes that may occur at the zero-crossing point, the output of the current loop can be used as the bridge arm voltage, and S1, S2, S3, and S4 can be controlled according to the relationship between the bridge arm voltage and VDC. The turn-on and turn-off of S1, S2, S3, and S4 may not need to not depend solely on the amplitude and polarity of the VAC. The current control loop being performed by controller 112 under different modes can allow current spikes to be reduced or removed without performing soft-start and without a need to shut off all switches in switching converter 116. The reduction of current spikes can lead to improved efficiency and stability of system 100. Also, without a need to use soft-start or to turn off all switches near the zero crossing point, software computational overhead and code complexity can be reduced, IAC can be controlled to avoid the freewheeling state, and there is no need to force the current control loop to stop during the current zero-crossing point.

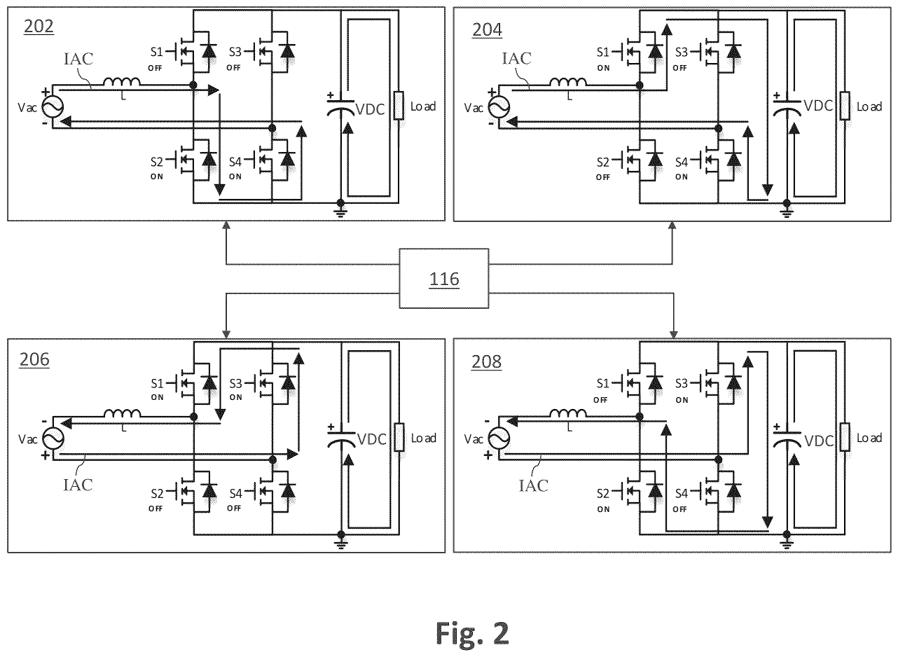

FIG. 2 is diagram showing different operation modes of an AC/DC converter in accordance with bi-directional digital power factor correction in one embodiment. Description of FIG. 2 can reference components shown in FIG. 1. In an example shown in FIG. 2, switching converter 116 can operate under different modes 202, 204, 206, 208. In mode 202, VAC can be in the positive half cycle and current IAC can flow from a positive terminal to a negative terminal as shown in FIG. 2. Switches S1, S3 can be turned off and switches S2, S4 can be turned on to form a closed loop including VAC and switches S2, S4. The AC current IAC can flow from the positive terminal of VAC to switch S2, then switch S4, then return to negative terminal of VAC, without contributing to VDC. Hence, a bridge output voltage (e.g., the midpoint voltage of the high frequency bridge arm formed by S1, S2 subtracting the midpoint voltage of the low frequency bridge arm formed by S3. S4) can be zero.

In mode 204, VAC can be in the positive half cycle and current IAC can flow from a positive terminal to a negative terminal as shown in FIG. 2. Switches S2, S3 can be turned off and switches S1, S4 can be turned on to form a closed loop including VAC and switches S1, S4. The AC current IAC can flow from the positive terminal of VAC to switch S1, then to switch S4 via VDC, then return to negative terminal of VAC. Hence, the bridge output voltage (e.g., the midpoint voltage of the high frequency bridge arm formed by S1, S2 subtracting the midpoint voltage of the low frequency bridge arm formed by S3. S4) can be +VDC since VAC is in the positive half cycle.

In mode 206, VAC can be in the negative half cycle and current IAC can flow in a reversed direction from the positive half cycle as shown in FIG. 2. Switches S2, S4 can be turned off and switches S1, S3 can be turned on to form a closed loop including VAC and switches S1, S3. The AC current IAC can flow from VAC to switch S3, then switch S1, then return to VAC without contributing to VDC. Hence, the bridge output voltage (e.g., the midpoint voltage of the high frequency bridge arm formed by S1, S2 subtracting the midpoint voltage of the low frequency bridge arm formed by S3. S4) can be zero.

In mode 208, VAC can be in the negative half cycle and current IAC can flow in a reversed direction from the positive half cycle as shown in FIG. 2. Switches S1, S4 can be turned off and switches S2, S3 can be turned on to form a closed loop including VAC and switches S2, S3. The AC current IAC can flow from VAC to switch S3, then to switch S2 via VDC, then return to VAC. Hence, the bridge output voltage (e.g., the midpoint voltage of the high frequency bridge arm formed by S1, S2 subtracting the midpoint voltage of the low frequency bridge arm formed by S3. S4) can be −VDC since VAC is in the negative half cycle.

Controller 112 described herein can be configured to perform a current control loop to control and regulate IAC regardless of whether VAC is in the positive half cycle or in the negative half cycle. By way of example, even though the states of switches S1, S2, S3, S4 under modes 202, 204 shown in FIG. 2 are predefined for positive half cycle, controller 112 can override the predefined settings to operate switching circuit 116 under modes 202, 204 when VAC is in negative half cycle in order to reduce current spikes at the zero-crossing point. Further, the AC voltage VAC can be provided as a feedforward voltage to the current control loop to offset the impact of the VAC voltage on controller 112. Furthermore, controller 112 can regulate IAC regardless of whether the zero-crossing point occurs from a positive-to-negative transition or a negative-to-positive transition.

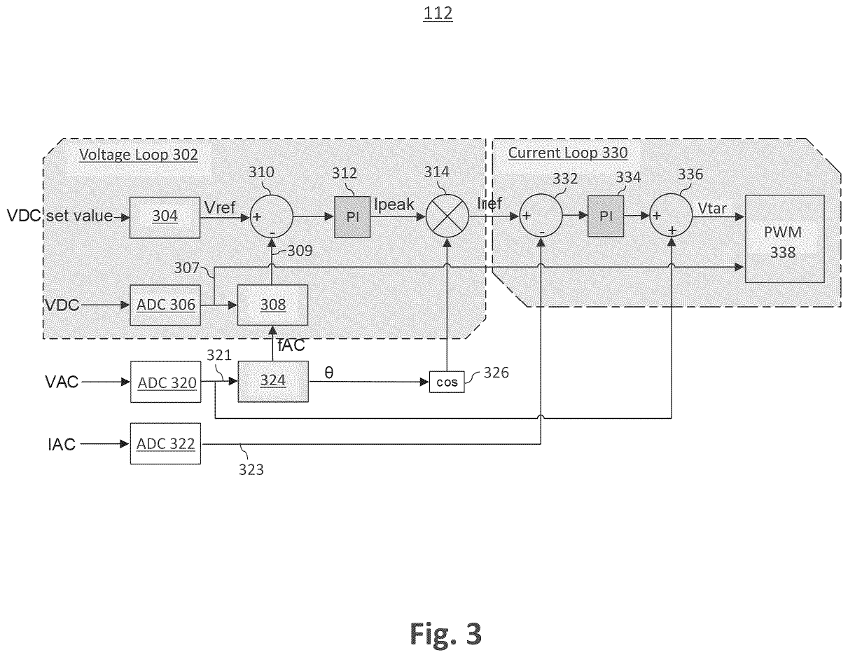

FIG. 3 is diagram showing an implementation of a controller in bi-directional digital power factor correction in one embodiment. Descriptions of FIG. 3 can reference components shown in FIG. 1 to FIG. 2. In an example shown in FIG. 3, switching converter 116 can be operating under PFC mode or a grid-connected inverter mode. When switching converter 116 is operating under PFC or grid-connected inverter mode, controller 112 can implement a voltage loop 302 and a current loop 330 shown in FIG. 3. The PFC mode can be when the converter 110 is connected to a power supply that supplies voltage VAC, and converter 110 can convert VAC into VDC. The grid-connected inverter mode can be when the converter 110 is connected to a power supply that supplies voltage VDC and connected to an AC power grid (e.g., VAC in FIG. 1), and converter 110 can convert VDC into VAC. Controller 112 can implement current loop 330 to control and regulate the amplitude and phase of feedback current IAC. Controller 112 can implement voltage loop 302 to stabilize VDC.

Controller 112 can apply a ramp function 304 on a VDC set value to generate a reference voltage Vref. The VDC set value be a target value being set for VDC being outputted by switching circuit 116. The VDC voltage being supplied and being converted into VAC under grid-connected inverter mode and being outputted by switching circuit 116 under PFC mode can be provided as a feedback voltage and an analog to digital converter (ADC 306) can convert VDC into a digital signal 307 that represents a voltage level of VDC. Digital signal 307 can be provided to a notch filter 308 and to a PWM generator 338 in controller 112.

The voltage VAC can be provided to an ADC 320 and current IAC can be provided to another ADC 322. ADC 320 can convert VAC into a digital signal 321 that is a digital representation of VAC. Digital signal 321 can be provided to a second-order generalized integrators phase locked loop (SOGI-PLL) 324. SOGI-PLL 324 can estimate and output a grid phase angle θ and frequencies fAC of the bi-directional power supply or power grid that provided VAC. The frequency fAC can be provided to notch filter 308. Notch filter 308 can be a digital notch filter that can attenuate or eliminate unwanted or narrow frequencies from a digital signal. In the embodiment shown in FIG. 3, notch filter 308 can remove twice the frequencies fAC from digital signal 307. Portions of digital signal 307 having frequencies not removed by notch filter 308 can be outputted as another digital signal 309. The digital signal 309 can be subtracted from the reference voltage Vref at a summation node 310, and the result, which can be an error signal, from the summation node 310 can be provide to a proportional-integral (PI) controller 312. The PI controller 312 can adjust its output, which can be a peak current Ipeak, proportionally to the error signal from summation node 310 and can integrate previous errors from summation node 310 over time to eliminate any steady-state error.

The grid phase angle θ can be applied to a cosine function 326 to phase shift the cosine function 326. The phase shifted cosine function can be combined with the peak current Ipeak at a node 314 to output a reference current Iref. ADC 322 can convert feedback current IAC into a digital signal 323 that is a digital representation of feedback current IAC. Digital signal 323 can be provided to a summation node 332, where digital signal 323 can be subtracted from the reference current Iref to generate a current error between feedback current IAC and the reference current Iref. The current error from the summation node 332 can be provide to a proportional-integral (PI) controller 334. The PI controller 334 can adjust its output, which can be a voltage level, proportionally to the current error from summation node 332 and can integrate previous current errors from summation node 332 over time to eliminate any steady-state error.

The digital signal 321 representing VAC can be added to the output of PI controller 334 at another summation node 336. The output from summation node 336 can be a target voltage Vtar that can be an AC voltage. The target voltage Vtar can be the bridge arm voltage which is defined by the midpoint voltage of high frequency bridge arm subtracting the midpoint voltage of low frequency bridge arm. A relationship among the target voltage Vtar, the voltage VAC, the inductance of boost inductor L, the switching period Δt of the switches and the feedback current IAC can be expressed as:

$$( V tar - V AC ) * Δ t = L * Δ IAC$$

In an aspect, for a voltage source converter such as switching circuit 116, during the switching cycles (e.g., as switches S1, S2, S3, S4 are being switched), the switching frequency can be significantly greater than the grid frequency, thus the VAC voltage is considered constant or remains unchanged during a switching cycle. At the same time, the inductance value L and switching period Δt can be fixed values, such that the AC current IAC can be controlled by adjusting the target voltage Vtar. Controller 112 can operate PI controller 334 to generate and adjust Vtar based on the difference between Iref and feedback current IAC. Therefore, controller 112 can control and regulate IAC by adjusting Vtar. In one embodiment, VAC being provided as a feedforward voltage can result in Vtar being a sum of the output from PI controller 334 and VAC (see summation node 336). Thus, the voltage difference acting on both ends of the inductor L, such as ΔV=Vtar−VAC, can be equivalent to the output of the PI controller 334 and the direct response of system 100 to potential disturbance caused by VAC can be realized. According to the deviation between the actual feedback value of IAC and the reference current Iref, through the adjustment of the PI controller 334, the bridge output voltage or target voltage Vtar can be adjusted to change the voltage difference AV across the inductor L, which leads to adjustment of IAC. Further, since the bridge output voltage depends on the current loop 330, bipolar modulation where the bridge output voltage can be positive or negative voltages can be realized and system 100 is not limited to unipolar modulation due to limitation of VAC polarity. Vac is regarded as a disturbance term, and its impact on the current loop is offset, which can speed up the adjustment of the current loop.

Controller 112 can operate PWM generator 338 to adjust a duty cycle D of the PWM control signals being used for switching the switches in switching circuit 116. By way of example, the duty cycle D can be expresses as

$$D = \frac{\vert V tar \vert}{V DC} .$$

Therefore, PWM generator 338 can determine the duty cycle for both bridge arms (e.g., the high frequency bridge implemented by S1, S2 and the low frequency bridge implemented by S3, S4) according to Vtar and VDC (represented as digital signal 307).

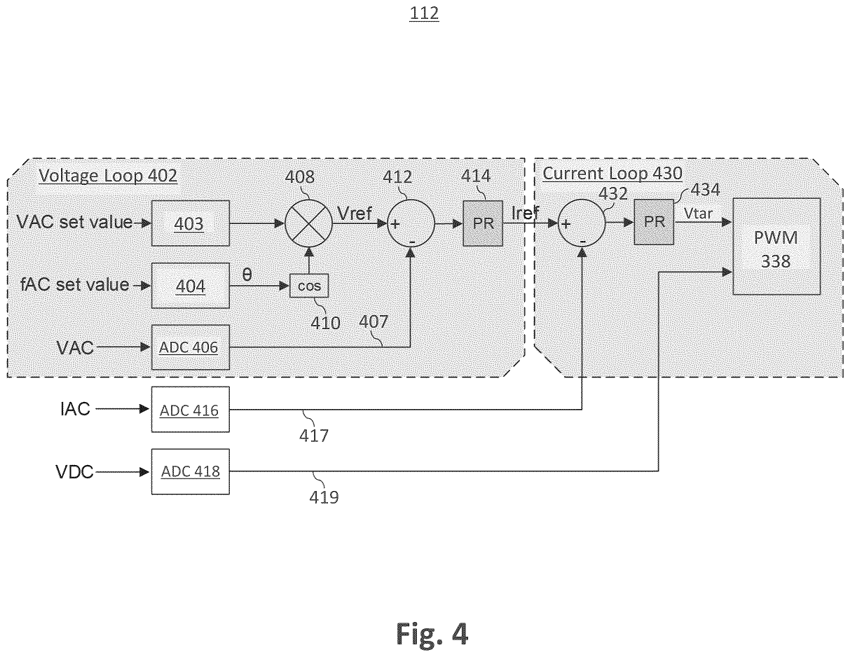

FIG. 4 is diagram showing an implementation of a controller in bi-directional digital power factor correction in one embodiment. Descriptions of FIG. 3 can reference components shown in FIG. 1 to FIG. 3. In an example shown in FIG. 4, switching converter 116 can be operating under an off-grid inverter mode. When switching converter 116 is operating under off-grid inverter mode, controller 112 can implement a voltage loop 402 and a current loop 430 shown in FIG. 4. The off-grid inverter mode can be when the converter 110 converts VDC into VAC, such as when the DC load is a battery and the battery needs to be discharged. Controller 112 can implement current loop 430 to control the amplitude and phase of IAC. Controller 112 can implement voltage loop 402 to output a sinusoidal AC voltage.

Controller 112 can apply a ramp function 403 on a VAC set value to generate a reference voltage Vref. The VAC set value be a target value being set for AC voltage VAC being outputted by converter 110 under the off-grid mode. A fAC set value that can be a frequency of the VAC signal can be provided to a phase detector 404 to determine a phase angle θ of VAC. The phase angle θ of VAC can be applied to a cosine function 410 to phase shift the cosine function 410. The phase shifted cosine function can be combined with the output of the ramp function 403 at a node 408 to generate a reference voltage Vref. A feedback of the VAC voltage can be received by an ADC 406. ADC 406 can convert the feedback of VAC into a digital signal 407 that is a digital representation of VAC. Digital signal 407 can be provided to a summation node 412 and summation node can subtract digital signal 407 from reference voltage Vref.

The output from summation node 412 can be provided to a proportional resonant (PR) controller 414 to introduce an infinite gain at the fundamental frequency of Vref to generate a reference current Iref with zero steady-state error. Reference current Iref can be provided to a summation node 432. The feedback current IAC of VAC can be provided to an ADC 416. ADC 416 can convert IAC into a digital signal 417. Digital signal 417 can be provided to summation node 432. Summation node 432 can subtract digital signal 417 from Iref. The output from summation node 432 can be provided to another PR controller 434 to generate target voltage Vtar. The VDC voltage being provided to switching circuit 116 can be provided to an ADC 418. ADC 418 can convert VDC into a digital signal 419 that represents a voltage level of VDC. Digital signal 419 can be provided to PWM generator 338 in controller 112. Controller 112 can operate PWM generator 338 to adjust a duty cycle D of the PWM control signals being used for switching the switches in switching circuit 116. PWM generator 338 can determine the duty cycle for both bridge arms (e.g., the high frequency bridge implemented by S1, S2 and the low frequency bridge implemented by S3, S4) according to Vtar and VDC (represented as digital signal 419).

As mentioned above, controller 112 can control and regulate IAC based on Vtar being determined by current loop 330 (FIG. 3, under grid-connected or PFC) and current loop 430 (FIG. 4, under off-grid). To control and regulate IAC at a current zero crossing point, controller 112 can perform bipolar modulation where both the high frequency bridge arm (S1, S2) and the low frequency bridge arm (S3, S4) can be operated, under different duty cycles that depend on the duty cycle variable

$$D = \frac{\vert V tar \vert}{V DC} .$$

In one embodiment, depending on the difference between Iref and feedback current IAC in current loops 330, 430, Vtar can have different polarity. By way of example, if Iref is greater than feedback current IAC then Vtar can be positive (e.g., greater than zero), if Iref is less than feedback current IAC, then Vtar can be negative (e.g., less than zero), and if Iref is equivalent to feedback current IAC, then Vtar can be zero. When Vtar is positive, or equal to zero, controller 112 can operate the high frequency bridge arm, or switches S1, S2, under complementary PWM signals having a duty cycle of D and operate the low frequency bridge arm, or switches S3, S4, under complementary PWM signals having a duty cycle of 0. When Vtar is negative, controller 112 can operate the high frequency bridge arm or switches S1, S2 under a duty cycle of 1-D and operate the low frequency bridge arm or switches S3, S4 under a duty cycle of 1. The operation of the high frequency bridge arm and the low frequency bridge arm based on Vtar can control IAC regardless of the polarity of VAC and regardless of whether converter 110 is operating as grid-connected inverter, PFC, or off-grid inverter.

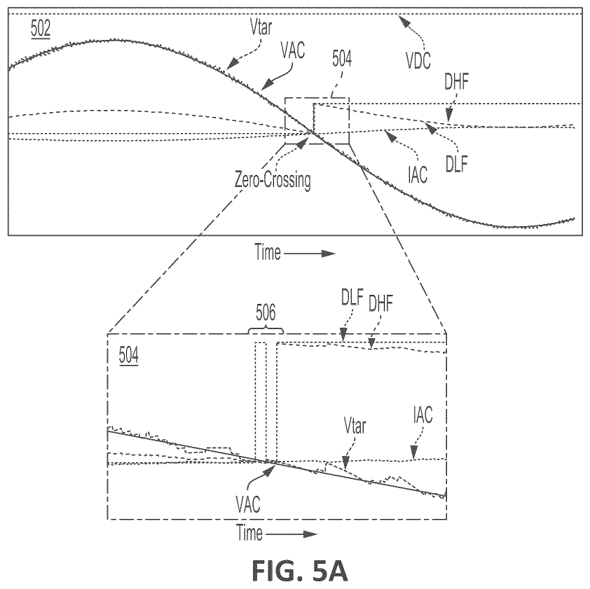

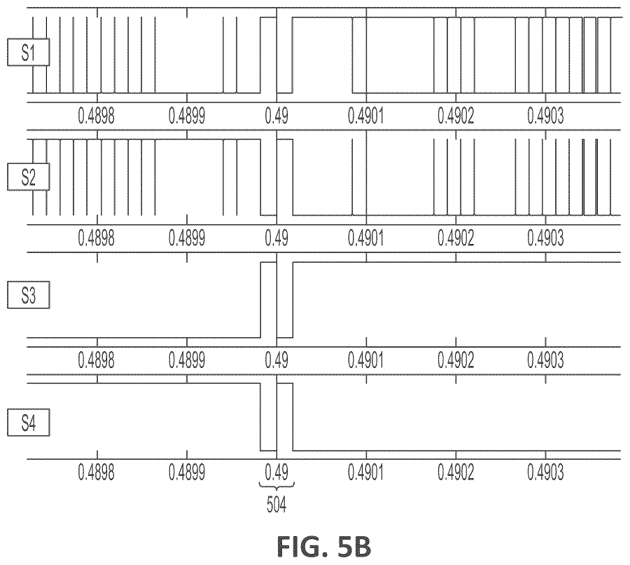

FIG. 5A and FIG. 5B are diagrams showing a result of an implementation of bi-directional digital power factor correction in one embodiment. Descriptions of FIG. 5A and FIG. 5B can reference components shown in FIG. 1 to FIG. 4. As shown by a set of waveforms 502 in FIG. 5A and PWM signals for switches S1, S2, S3, S4 in FIG. 5B, the duty cycles of the high frequency arm (DHF) and the low frequency arm (DLF) continues to toggle at zero-crossing time 504 such that controller 112 does not turn off all switches S1, S2, S3, S4. In one embodiment, controller 102 can perform a bipolar modulation at approximately the zero crossing time 504. In the bipolar modulation shown in FIG. 5A and FIG. 5B, the switches S1, S2, S3, S4 are being switched by controller 112 in a nonconventional manner. By way of example, conventionally, the low frequency bridge arm (e.g., switches S3, S4) are only switched once when VAC changes polarity (from positive half cycle to negative half cycle or vice versa). The control loops shown in FIG. 3 and FIG. 4 can allow controller 112 to override the conventional switching to control IAC at approximately the zero-crossing time 504. In the example shown in FIG. 5A and FIG. 5B, during the bipolar modulation at zero crossing time 504, the duty cycle of the low frequency arm DLF switches (e.g., S3, S4) more than one times during a time duration 506, such that IAC can be regulated and current spikes do not occur at the zero crossing time. This adjustment of IAC at approximately the zero-crossing time 504 can gradually adjust the duty cycle D without suddenly increasing D from zero to 100% as in conventional systems where all switches are turned off, and the gradual adjustment can allow sufficient recovery time of the switches during transitions. Note that the bipolar modulation can be performed regardless of whether VAC is in the positive or negative half cycle at approximately the zero-crossing time. As a result of controlling IAC using the techniques described in the present disclosure, current spikes at zero-crossing point can be reduced or eliminated.

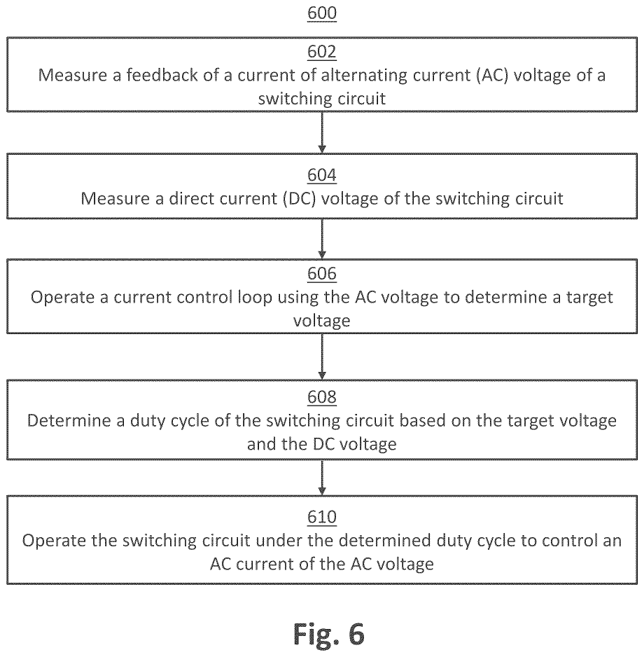

FIG. 6 is a flow diagram illustrating a process to implement bi-directional digital power factor correction in one embodiment. A process 600 can include one or more operations, actions, or functions as illustrated by one or more of blocks 602, 604, 606, and/or 608. Although illustrated as discrete blocks, various blocks can be divided into additional blocks, combined into fewer blocks, eliminated, performed in different order, or performed in parallel, depending on the desired implementation.

Process 600 can be performed by a controller, such as controller 112 described herein, of an AC/DC converter to reduce current spikes at zero-crossing point. Process 600 can begin at block 602. At block 602, the controller can measure a feedback of a current of an alternating current (AC) voltage of a switching circuit. In one embodiment, the switching circuit can be a totem pole bridgeless power factor correction (PFC) circuit. In one embodiment, the switching circuit comprises a plurality of hybrid Silicon Carbide-Silicon metal-oxide-semiconductor field-effect transistors (SiC—Si MOSFETs).

Process 600 can proceed from block 602 to block 604. At block 604, the controller can measure a direct current (DC) voltage of the switching circuit. In one embodiment, the controller can operate the switching circuit under a PFC mode. Under the PFC mode, the AC voltage can be an input voltage to the switching circuit and the DC voltage can be an output voltage of the switching circuit. In one embodiment, the controller can operate the switching circuit under one of a grid-connected and an off-grid inverter mode. Under the grid-connected and the off-grid inverter mode, the DC voltage can be an input voltage to the switching circuit and the AC voltage can be an output voltage of the switching circuit.

Process 600 can proceed from block 604 to block 606. At block 606, the controller can operate a current control loop using the feedback of the current and the AC voltage to determine a target voltage. Process 600 can proceed from block 606 to block 608. At block 608, the controller can determine a duty cycle of the switching circuit based on the target voltage and the DC voltage. In one embodiment, the controller can operate the current control loop by determining whether or not to use the AC voltage as a feedforward voltage to determine the target voltage.

Process 600 can proceed from block 608 to block 610. At block 610, the controller can operate the switching circuit under the determined duty cycle to control the current of the AC voltage. In one embodiment, operation of the switching circuit under the determined duty cycle can include a bipolar modulation. In one embodiment, operation of the switching circuit under the determined duty cycle can include one of operating the switching circuit when the input AC voltage is in a positive half cycle and operating the switching circuit when the input AC voltage is in a negative half cycle.

In one embodiment, the controller can determine the target voltage is greater than or equal to zero. In response to determining the target voltage is greater than or equal to zero, the controller can operate a high frequency bridge arm of the switching converter under the determined duty cycle of D and operate a low frequency bridge arm of the switching converter under a duty cycle of zero. The controller can determine the target voltage is less than zero. In response to determining the target voltage is less than zero, the controller can operate the high frequency bridge arm of the switching converter under a duty cycle of one minus the determined duty cycle of D and operate the low frequency bridge arm of the switching converter under a duty cycle of one.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The disclosed embodiments of the present invention have been presented for purposes of illustration and description but are not intended to be exhaustive or limited to the invention in the forms disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method comprising:
measuring a feedback of a current of an alternating current (AC) voltage of a switching circuit;
measuring a direct current (DC) voltage of the switching circuit;
operating a current control loop using the feedback of the current and the AC voltage to determine a target voltage;
determining a duty cycle of the switching circuit based on the target voltage and the DC voltage; and
operating the switching circuit under the determined duty cycle to control the current of the AC voltage.

2. The method of claim 1, wherein the switching circuit is a totem pole bridgeless power factor correction (PFC) circuit.

3. The method of claim 1, further comprising:
operating the switching circuit under one of a PFC mode, wherein under the PFC mode, the AC voltage is an input voltage to the switching circuit and the DC voltage is an output voltage of the switching circuit.

4. The method of claim 1, further comprising:
operating the switching circuit under one of a grid-connected and an off-grid inverter mode, wherein under the grid-connected and the off-grid inverter mode, the DC voltage is an input voltage to the switching circuit and the AC voltage is an output voltage of the switching circuit.

5. The method of claim 1, wherein operation of the switching circuit under the determined duty cycle comprises a bipolar modulation.

6. The method of claim 1, wherein operating the switching circuit under the determined duty cycle comprises one of:
operating the switching circuit when the input AC voltage is in a positive half cycle; and
operating the switching circuit when the input AC voltage is in a negative half cycle.

7. The method of claim 1, further comprising:
determining the target voltage is greater than or equal to zero;
in response to determining the target voltage is greater than or equal to zero:
operating a high frequency bridge arm of the switching converter under the determined duty cycle of D; and
operating a low frequency bridge arm of the switching converter under a duty cycle of zero;
determining the target voltage is less than zero; and
in response to determining the target voltage is less than zero:
operating the high frequency bridge arm of the switching converter under a duty cycle of one minus the determined duty cycle of D; and
operating the low frequency bridge arm of the switching converter under a duty cycle of one.

8. A semiconductor device comprising:
a switching circuit;
a gate driver configured to drive at least one switch in the switching circuit; and
a controller configured to:
measure a feedback of a current of an alternating current (AC) voltage of the switching circuit;
measure a direct current (DC) voltage of the switching circuit;
operate a current control loop using the feedback of the current to determine a target voltage;
determine a duty cycle of the switching circuit based on the target voltage and the DC voltage; and
generate control signals for the gate driver to drive the switching circuit under the determined duty cycle to control the current of the AC voltage.

9. The semiconductor device of claim 8, wherein the switching circuit is a totem pole bridgeless power factor correction (PFC) circuit.

10. The semiconductor device of claim 8, wherein the controller is configured to:
operate the switching circuit under a PFC mode, wherein under the PFC mode, the AC voltage is an input voltage to the switching circuit and the DC voltage is an output voltage of the switching circuit.

11. The semiconductor device of claim 8, wherein the controller is configured to:
operate the switching circuit under one of a grid-connected and an off-grid inverter mode, wherein under grid-connected and the off-grid inverter mode, the DC voltage is an input voltage to the switching circuit and the AC voltage is an output voltage of the switching circuit.

12. The semiconductor device of claim 8, wherein operation of the switching circuit under the determined duty cycle comprises a bipolar modulation.

13. The semiconductor device of claim 8, wherein operation of the switching circuit under the determined duty cycle comprises one of:
operate the switching circuit when the input AC voltage is in a positive half cycle; and
operate the switching circuit when the input AC voltage is in a negative half cycle.

14. The semiconductor device of claim 8, wherein the controller is configured to:
determine the target voltage is greater than or equal to zero;
in response to determination that the target voltage is greater than or equal to zero:
operate a high frequency bridge arm of the switching converter under the determined duty cycle of D; and
operate a low frequency bridge arm of the switching converter under a duty cycle of zero;
determine the target voltage is less than zero; and
in response to determination that the target voltage is less than zero:
operate the high frequency bridge arm of the switching converter under a duty cycle of one minus the determined duty cycle of D; and
operate the low frequency bridge arm of the switching converter under a duty cycle of one.

15. A semiconductor device comprising:
a controller configured to:
measure a feedback of a current of an alternating current (AC) voltage of a switching circuit;
measure a direct current (DC) voltage of the switching circuit;
operate a current control loop using the feedback of the current to determine a target voltage;
determine a duty cycle of the switching circuit based on the target voltage and the DC voltage; and
operate the switching circuit under the determined duty cycle to control the current of the AC voltage.

16. The semiconductor device of claim 15, wherein the switching circuit is a totem pole bridgeless power factor correction (PFC) circuit.

17. The semiconductor device of claim 15, wherein the controller is configured to:
operate the switching circuit under a PFC mode, wherein under the PFC mode, the AC voltage is an input voltage to the switching circuit and the DC voltage is an output voltage of the switching circuit.

18. The semiconductor device of claim 15, wherein the controller is configured to:
operate the switching circuit under one of a grid-connected and an off-grid inverter mode, wherein under the grid-connected and the off-grid inverter mode, the DC voltage is an input voltage to the switching circuit and the AC voltage is an output voltage of the switching circuit.

19. The semiconductor device of claim 15, wherein operation of the switching circuit under the determined duty cycle comprises one of:
operate the switching circuit when the input AC voltage is in a positive half cycle; and
operate the switching circuit when the input AC voltage is in a negative half cycle.

20. The semiconductor device of claim 15, wherein the controller is configured to:
determine the target voltage is greater than or equal to zero;
in response to determination that the target voltage is greater than or equal to zero:
operate a high frequency bridge arm of the switching converter under the determined duty cycle of D; and
operate a low frequency bridge arm of the switching converter under a duty cycle of zero;
determine the target voltage is less than zero; and
in response to determination that the target voltage is less than zero:
operate the high frequency bridge arm of the switching converter under a duty cycle of one minus the determined duty cycle of D; and
operate the low frequency bridge arm of the switching converter under a duty cycle of one.
